(19) United States
(12) Patent Application Publication
(10) Pub. No.: US 2021/0132196 A1
(43) Pub. Date: May 6, 2021

(54) FLAT OPTICS WITH PASSIVE ELEMENTS FUNCTIONING AS A TRANSFORMATION OPTICS AND A COMPACT SCANNER TO COVER THE VERTICAL ELEVATION FIELD-OF-VIEW

(71) Applicant: Lookit.ai, San Jose, CA (US)

(72) Inventors: Jack Tsai, San Jose, CA (US); Rickmer E. Kose, San Francisco, CA (US)

(21) Appl. No.: 17/090,585

(22) Filed: Nov. 5, 2020

Related U.S. Application Data
(60) Provisional application No. 62/937,582, filed on Nov. 19, 2019.
(60) Provisional application No. 62/937,577, filed on Nov. 19, 2019.
(60) Provisional application No. 62/931,652, filed on Nov. 6, 2019.

(51) Int. Cl. G01S 7/481; G02B 26/12; G01S 17/931; G01S 17/89; G02B 27/30

(52) U.S. Cl. CPC G01S 7/4817; G02B 26/12; G02B 27/30; G01S 17/89; G01S 17/931

(57) ABSTRACT

A 360-degree Field-Of-View LIDAR is capable of delivering light to a target and detecting light reflected off a given target in order to determine the distance from the light source to the target over the entire 360-degree surrounding. The LiDAR has such capability because of the built-in light source, detector, and scanner which can steer the light source and the detector to cover the entire azimuthal angles. In some embodiments, the LiDAR has the unique arrangement of the light source and the detector which are fixed to a base while the rotating scanner and a flat optics contains motor, scanning mirror, and metasurface/flat optics to project the light source to its surroundings as well as receiving light from surroundings. In particular, flat optics perform the function of transforming the reference frame and beam steering in the vertical direction.

### CROSS-REFERENCE TO RELATED APPLICATION(S)

This application claims priority under 35 U.S.C. § 119(e) of the U.S. Provisional Patent Application Ser. No. 62/937,582, filed Nov. 19, 2019 and titled, “Suspension Damper System for Vibration Control of Time of Flight System,” U.S. Provisional Patent Application Ser. No. 62/937,577, filed Nov. 19, 2019 and titled, “Closed Loop Temperature Controlled Time-Of-Flight System,” U.S. Provisional Patent Application Ser. No. 62/931,652, filed Nov. 6, 2019 and titled, “Flat Optics With Passive Elements Functioning As A Transformation Optics And A Compact Scanner To Cover The Vertical Elevation Field-Of-View,” which are all hereby incorporated by reference in their entireties for all purposes.

### FIELD OF THE INVENTION

The present invention relates to a lens system in the field of Light Detection and Ranging (LiDAR).

### BACKGROUND OF THE INVENTION

In the previous LiDAR design with far-field and near-field object detection capability, the arrangement of lasers and detectors point towards a specific vertical elevation direction. For each vertical elevation angle which is defined by one specific laser and detector pair, the laser and detector pair is mechanically aligned for that particular elevation and azimuthal angles.

### SUMMARY OF THE INVENTION

The LiDAR optical system described herein differs from the previous configuration such that a Vertical-Cavity-Surface-Emitting Laser (VCSEL) array with a thousand (or another number) emitter elements (each emitter has its predefined location) comes in a semiconductor chip package. Similarly, the Single-Photon Avalanche Detector (SPAD) array with a thousand (or another number) detector elements comes in a semiconductor chip package. The semiconductor chips are packaged with flat optics as a single device and are mounted on a rigid and stationary base of the LiDAR. The optical portion of the LiDAR configuration includes a rotating periscope capable of scanning the entire 360 azimuthal angles, three (or more) unique metasurface-based flat optics, emitters, and detectors. As the periscope rotates about its vertical rotating axis, the periscope mirror can change the elevation angle of each laser and detector pair. This allows the elevation pointing angle of the laser/detector pair to traverse an oscillating path in space and can therefore generate a denser spatial image as compared to an earlier design with fixed elevation. The ability to change the vertical elevation angle provides the LiDAR with variable spatial resolution. The benefits of pairing metasurface-based flat optics with the rotating periscope are two fold: achieving superior spatial resolution and enabling variable resolution for the far-field targets versus near field targets. Additionally, the spacing and form factor are reduced. The flat optics contain an array of pillars on top of a transparent substrate, and they are uniquely arranged to form a geometric pattern for light transmission from the VCSEL array to the target and from the target to the SPAD array. In some embodiments, it is the design of the pattern, the thinness of the flat optics, its capability to perform the coordinate transformation, and beam steering that makes the flat optics unique. Finally, the flat optics allow the overall size of the LiDAR to be very compact.

### BRIEF DESCRIPTION OF THE DRAWINGS

FIG. 1 illustrates a diagram of the angular spread for near-field versus far-field according to some embodiments.

FIG. 2 illustrates the oscillating path that emitter traverses as the deflecting mirror rotates about its vertical axis according to some embodiments.

FIG. 3 illustrates the change in vertical elevation of a single emitter, 2×2 emitter array, 4×4 emitter array as function of azimuthal angle rotation according to some embodiments.

FIG. 4 illustrates the change in vertical elevation of an 8×8 emitter array as function of azimuthal angle rotation according to some embodiments.

FIG. 5 illustrates a side view of a cross section view of the LiDAR optical system according to some embodiments.

FIG. 6 illustrates a diagram of assembly of the VCSEL and SPAD subassembly according to some embodiments.

FIG. 7 illustrates a close-up diagram of the VCSEL and SPAD subassembly according to some embodiments.

FIG. 8 illustrates a diagram of assembly of the periscope-motor subassembly according to some embodiments.

FIG. 9 illustrates a front view of a cross section view of the inner construction of the LiDAR optical system according to some embodiments.

FIG. 10 illustrates a side view of a cross section view of the inner construction of the LiDAR optical system according to some embodiments.

FIG. 11 illustrates an exemplary 2×5 VCSEL array with 10 VCSEL dies according to some embodiments.

FIG. 12 illustrates the working principles of collimating flat optics and its ability to reduce the beam divergence from the emitter according to some embodiments.

FIG. 13 illustrates the placement of flat optics relative to the VCSEL array and how light is more collimated by the flat optics according to some embodiments.

FIG. 14 illustrates a diagram of a metasurface/flat optics implementation according to some embodiments.

FIG. 15 illustrates a diagram of a meta-atom deflection configuration according to some embodiments.

FIG. 16 illustrates a diagram of a meta-atom deflection configuration according to some embodiments.

FIG. 17 illustrates a diagram of an antenna pillar polarizing the incident beam at subwavelength level and with each pillar offset by certain phase delay to deflect the incoming light beam to an intended angle according to some embodiments.

FIG. 18 illustrates an exemplary 1×16 SPAD detector array with 16 APD elements according to some embodiments.

FIG. 19 illustrates an exemplary 1×16 SPAD detector array with 16 APD elements according to some embodiments.

FIGS. 20 and 21 illustrate a flat optics-based focusing lens that can focus the reflected light from the target into individual detector elements according to some embodiments.

FIG. 22 illustrates how the array of emitters on the target undergoes rotation as the motor rotates according to some embodiments.

FIG. 23 illustrates the periscope mirror rotating in conjunction with the deflector/metasurface optics according to some embodiments.

FIG. 24 illustrates metasurface/flat optics which can passively steer the laser beam to a given vertical elevation according to some embodiments.

FIG. 25 illustrates the electronics for controlling the LiDAR optical system according to some embodiments.

FIG. 26 illustrates a view of the inner construction of the LiDAR showing the axial field motor and the rotating mirror according to some embodiments.

FIG. 27 illustrates the angular resolution of the image which is also defined as spatial resolution according to some embodiments.

FIG. 28 illustrates an optical system with Risley Scanner design according to some embodiments.

FIG. 29 illustrates a combination of a rotating mirror and the deflecting flat optics can operate similarly to Risley Prisms which can steer the laser beam to a given vertical elevation according to some embodiments.

FIGS. 30A-B illustrate diagrams and analysis of deflection by an aperiodic meta-atoms structure according to some embodiments.

FIG. 31 illustrates a chart of deflection information by aperiodic supercells according to some embodiments.

FIG. 32 illustrates a diagram of a deflector metasurface at 0.5 degrees according to some embodiments.

FIG. 33 illustrates a diagram of a deflector metasurface at 2.0 degrees according to some embodiments.

FIG. 34 illustrates diagrams of vertical and horizontal deflector metasurfaces according to some embodiments.

FIG. 35 illustrates a chart of relative displacement information of pillars according to some embodiments.

### DETAILED DESCRIPTION OF THE PREFERRED EMBODIMENT

A Time-Of-Flight (TOF) optical system (also referred to as a LiDAR optical system) is designed to measure the total time it takes for a photon from a laser to travel to a target at some distance away and the reflected photon from the target back to the detector. Depending on how much time it takes for the photons (traveling at the speed of light) from the lasers to hit the target and the reflected photons to be detected by the detector, the total travel distance can be determined. The TOF or LiDAR optical system as described herein differs from the previous implementations in how the LiDAR optical system addresses the changing of a reference frame as the periscope mirror rotates, and how the LiDAR optical system performs a vertical scan.

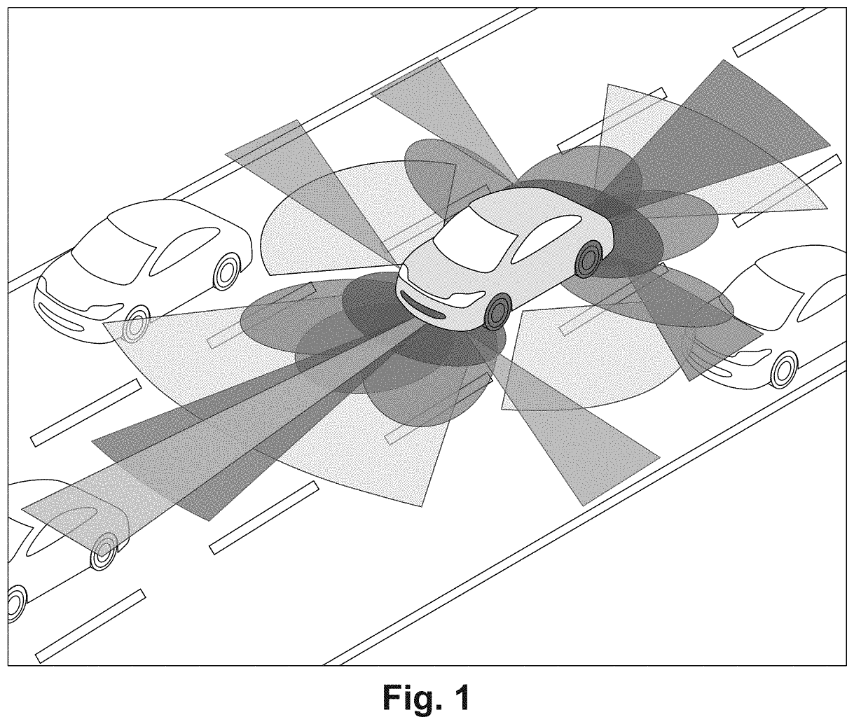

FIG. 1 illustrates a diagram of the angular spread for near-field versus far-field according to some embodiments. For near-distance, a larger angular spread is used, and far-distance uses a smaller angular spread. The angular spread is defined in both the vertical and horizontal directions. The use of the LiDAR optical system on a vehicle such as a car or an autonomous car enables features such as adaptive cruise control, collision avoidance, emergency braking, pedestrian detection, environment mapping, park assistance, lane departure warning, traffic sign recognition, cross-traffic alerts, digital side mirror, surround view, blind spot detection, rear collision warning, and/or rearview mirror. The LiDAR optical system is able to be implemented to detect objects in any direction such as the front, sides and back of the vehicle.

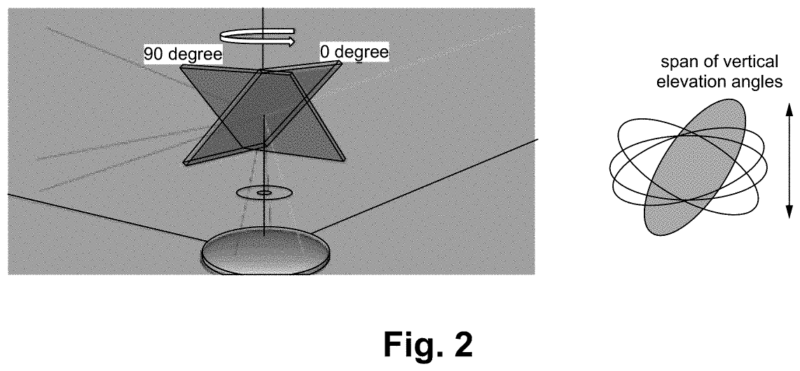

FIG. 2 illustrates the oscillating path that emitter traverses as the deflecting mirror rotates about its vertical axis according to some embodiments. Any given emitter of a fixed position will change the elevation angle as the mirror rotates. As the detecting mirror rotates about its vertical axis, the deflected light traverses an oscillating path.

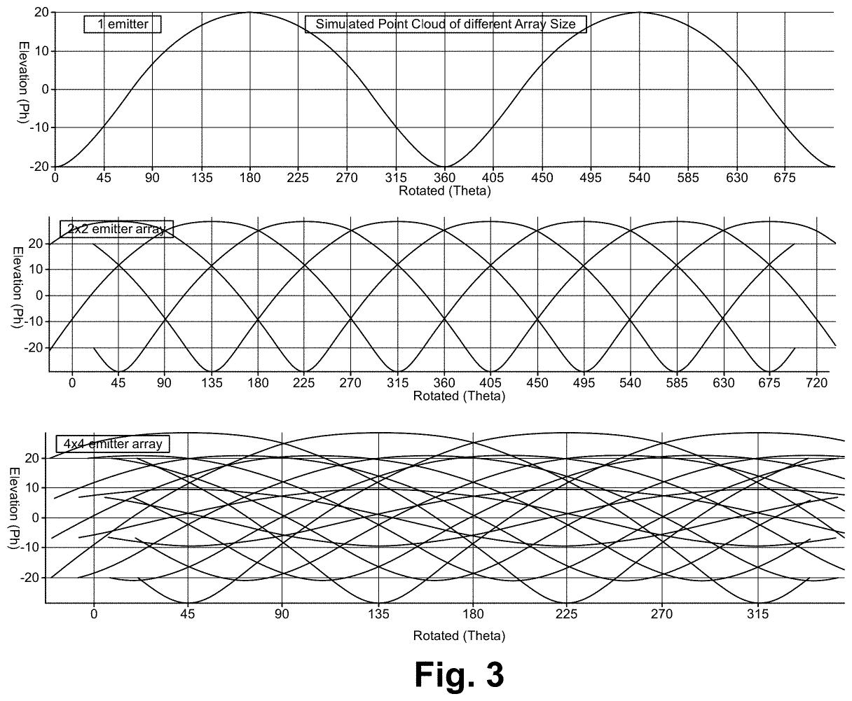

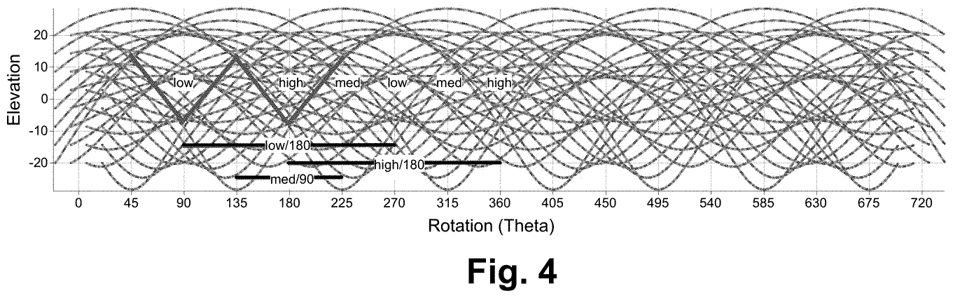

As shown in FIG. 3, the starting vertical elevation from a given emitter undergoes changes in the vertical elevation angle as the motor rotates from 0 degrees to 360 degrees in the azimuthal angles. FIG. 3 also shows the scanning vertical pattern for 1 emitter, a 2×2 emitter array and a 4×4 emitter array as a function of horizontal angles. Although 1, 2×2 and 4×4 emitter arrays are discussed, an 8×8 emitter array (FIG. 4), a 16×16 emitter array and beyond are able to be utilized. The changes in the vertical elevation angle as the periscope rotates occur due to the fact that each emitter/detector pair of particular elevation angle traverses an oscillating path as shown FIG. 3. Each elliptical path as the motor rotates is different for an emitter with a different starting vertical elevation angle, and the path repeats itself after a full 360° horizontal rotation.

FIG. 4 illustrates the change in vertical elevation of an 8×8 emitter array as a function of azimuthal angle rotation according to some embodiments. The vertical axis represents the vertical elevation angle spread, and the horizontal axis represents the azimuthal angle scan. Points coverage is a function of FOV (vertical and horizontal). Since the LiDAR optical system described herein has variable vertical elevations across HFOV, there is a more dense point cloud center at 180° with a with of +90° and a less dense point cloud towards higher elevation angles.

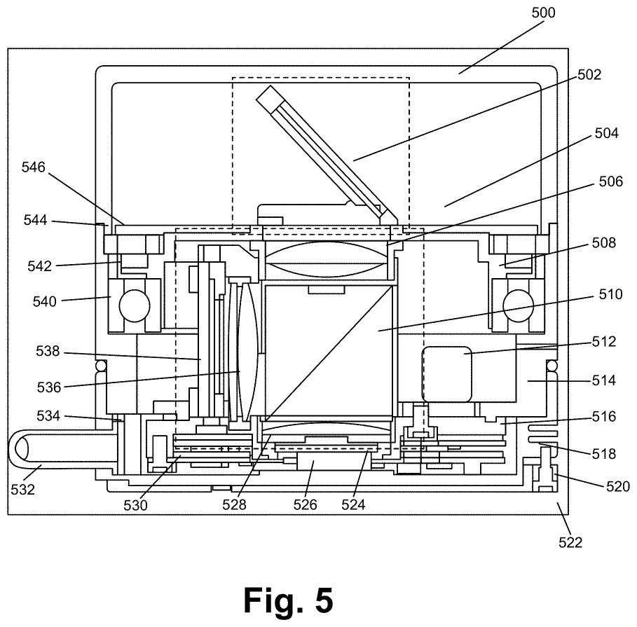

FIG. 5 illustrates a side view of a cross section view of the LiDAR optical system according to some embodiments. Aspects of the LiDAR optical system include a VCSEL array 524 as the light-emitting source, a Single-Photon Avalanche Detector (SPAD) array 538 as the light detection array, metasurface-based optical lens elements 540 (also referred to as an optical collimation lens (flat optics) elements) to collimate the exit laser beam from the VCSEL array 524, metasurface-based optical lens elements 546 (also referred to as optical focusing lens (flat optics) elements) to focus the returned laser beam to the SPAD array 538, an optical beam splitter 510 that guides both the outgoing laser emitter beam path from the VCSEL array 524 to the rotating periscope mirror 502 out to the target as well as the reflected laser beam returning from the target back to the photodetector array 538, a metasurface-based light deflector element 506 (also referred to as a deflecting optical lens (flat optics) element) along the optical path in between the beam splitter 510 and the periscope mirror 502 as part of the light delivery system where the purpose is to deflect the collimated laser light to a specific vertical elevation angle before the light goes to a reflecting mirror 502 on an axial field motor (similar to a periscope of a submarine), a cooling system (of the L beam), a vibration reduction system, a moisture/humidity mitigation system, and electronics that control the lasers, detectors and motor. In some embodiments, fewer or additional components are included in the LiDAR optical system.

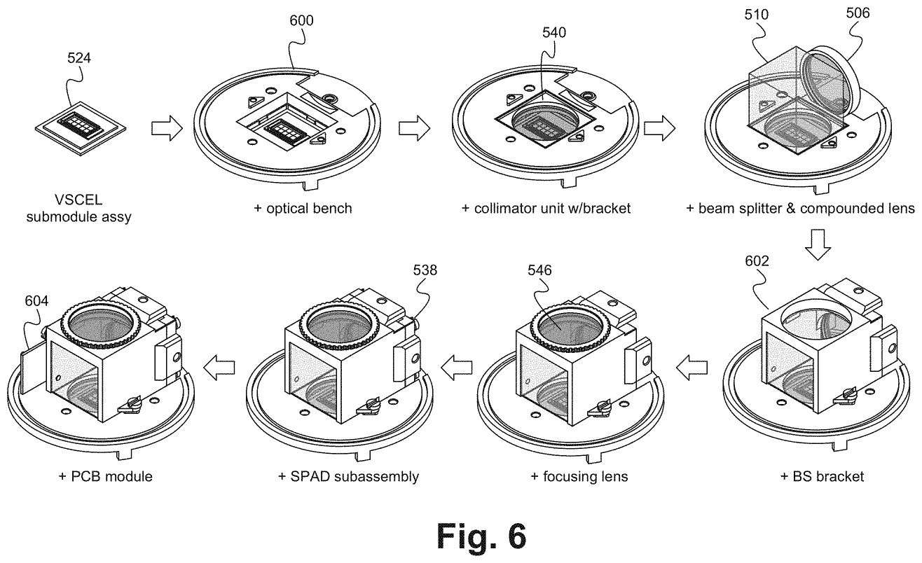

FIG. 6 illustrates a diagram of assembly of the VCSEL and SPAD subassembly according to some embodiments. The VCSEL array 524 is positioned within an optical bench 600. A collimator lens 540 is on top of the VCSEL array 524 within the optical bench 600. A beam splitter 510 is positioned on the collimator lens 540 with a compounded lens (e.g., deflecting lens) 506 is positioned next to the beam splitter 510. A bracket 602 covers the assembly thus far, with an aperture configured to receive a focusing lens 546. Attached to the back of the bracket 602 is the SPAD array 538. Additionally, a Printed Circuit Board (PCB) module 604 is attached to the outside of the bracket 602. The configuration and orientation of the components described herein are able to be modified.

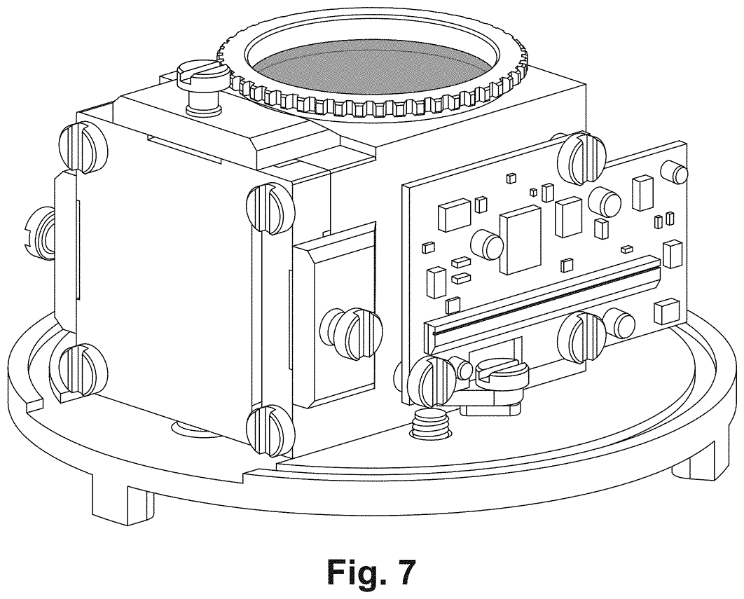

FIG. 7 illustrates a close-up diagram of the VCSEL and SPAD subassembly according to some embodiments. Multiple screws (e.g., one on each side) are able to be used for fine positioning of the SPAD array, where the screws are able to be removed after the positioning is locked. A threaded knob is able to be used to adjust the focus of the lens (e.g., the focusing lens). One or two side walls of the bracket are able to be used to mount the PCB module. The SPAD array is able to be behind or part of a lid/covering.

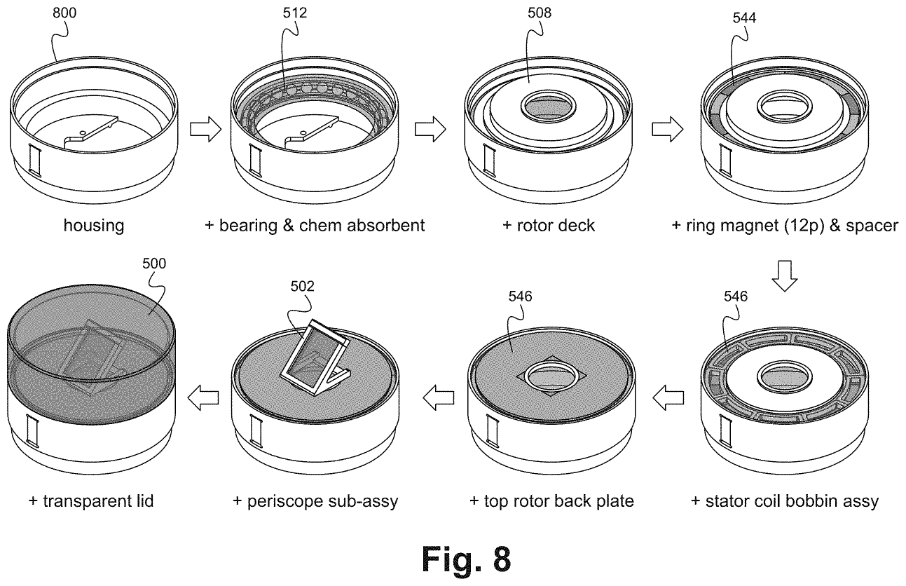

FIG. 8 illustrates a diagram of assembly of the periscope-motor subassembly according to some embodiments. A housing 800 is configured to receive bearings and a chemical absorbent 512. On top of the bearing and chemical absorbent 512 is the rotor deck 508. A ring magnet 544 is positioned on the rotor deck 508. A stator coil bobbin assembly 546 is positioned above the ring magnet 544. A top rotor back plate 504 covers the assembly. A periscope bracket with mirror 502 is positioned and configured for directing a laser beam, and a transparent lid 500 covers the assembly.

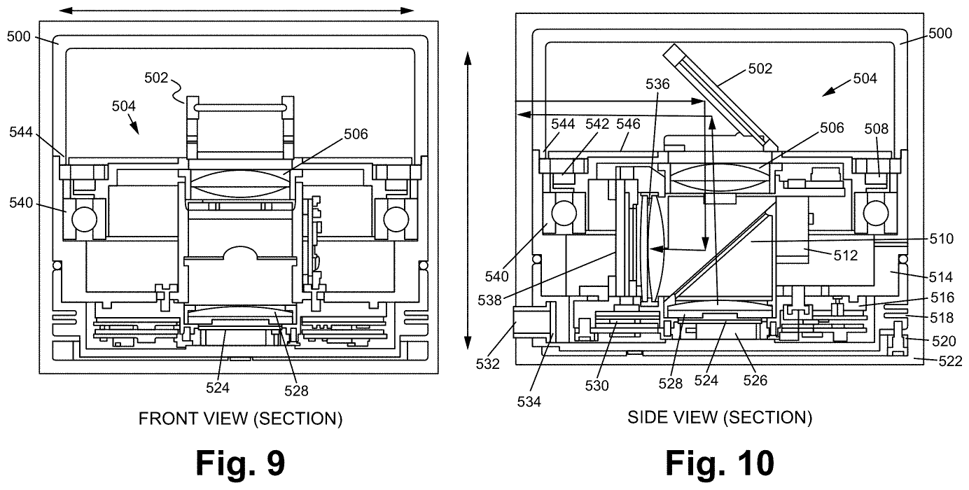

FIG. 9 illustrates a front view of a cross section view of the inner construction of the LiDAR optical system according to some embodiments. As seen from this view, the LiDAR optical system includes: a transparent cover lid 500, a periscope bracket with mirror 502, a top rotor back plate 504, a flat optics lens 506, a Vertical-Cavity-Surface-Emitting Laser (VCSEL) illuminator plate assembly 524, a collimator lens (e.g., flat optics) 528, a thin section bearing 540, and a 12-pole axial magnet 544. Additional components are able to be seen in other views of the LiDAR optical system. In some embodiments, fewer or additional components are included in the LiDAR optical system. In some embodiments, variations of components are included in the LiDAR optical system.

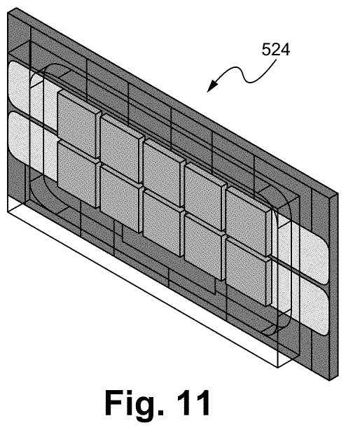

FIG. 10 illustrates a side view of a cross section view of the inner construction of the LiDAR optical system according to some embodiments. The LiDAR optical system includes: a transparent cover lid 500, a periscope bracket with mirror 502, a top rotor back plate 504, a flat optics lens 506, a rotor deck 508, a beam splitter with a holder bracket 510, a chemical absorbent 512, a housing 514, an optical bench 516, a heat sink 518, 3x springs with screws 520, a damper ring block 522, a VCSEL illuminator plate assembly 524, a ThermoElectric Cooler (TEC) (with thermal grease) 526, a collimator lens (e.g., flat optics) 528, dual stack PCBAs with foam interleave 530, an external outlet for data and power 532, an O-ring 534, a compound lens set assembly (e.g., flat optics) 536, a Single-Photon Avalanche Detector (SPAD) board assembly 538, a thin section bearing 540, a spacer ring 542, a 12-pole axial magnet 544, and a 9-coil stator bobbin 546. In some embodiments, fewer or additional components are included in the LiDAR optical system.

The side view of the LiDAR optical system shows the laser beam being emitted from the VCSEL illuminator plate assembly 524 through the beam splitter 510 to the periscope mirror 502 toward an object which reflects the beam (or part of the beam back to the periscope mirror 502 through the beam splitter 510 which directs the returning beam to the compound lens set assembly 536.

The configuration of the LiDAR optical system described herein eliminates the need to have the lasers and detector be co-located with a rotating spindle. The returned light from the target is intercepted by the periscope mirror 502 and guided into the detector array through the beam splitter 510 and focusing lens 536. The described configuration improves the overall electrical signal integrity because instead of inductive coupling as in the previous implementation, there is a physical connection that connects the signal lines and power supply lines of both emitters and detectors.

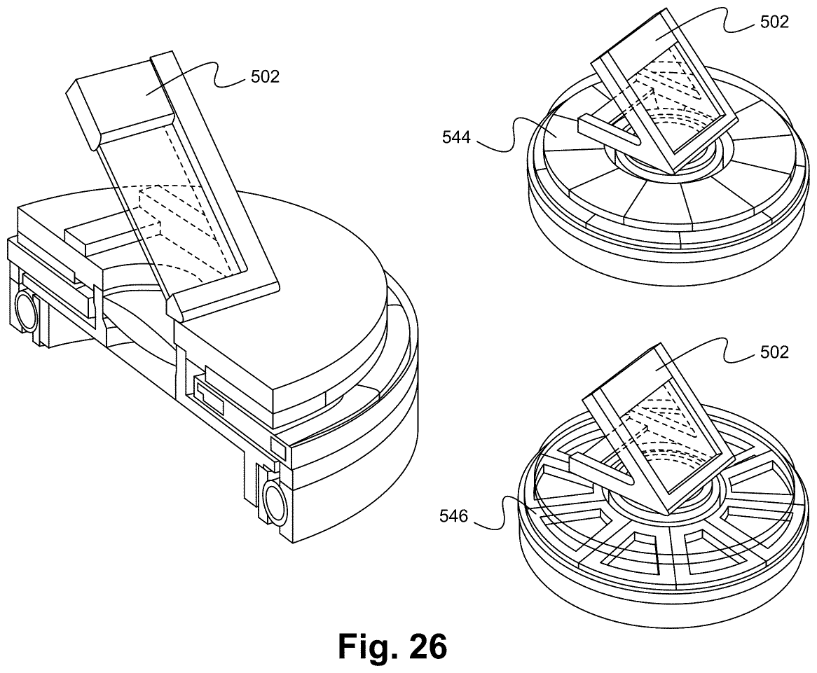

FIG. 26 illustrates the inner construction of the LiDAR showing the axial field motor and the rotating mirror. Specifically, the periscope mirror 502 is able to be moved using the motor magnetic ring 544 and the motor stator bobbin assembly 546. Another bearing is able to be added to limit the thrust effect if the LiDAR is mounted upside down.

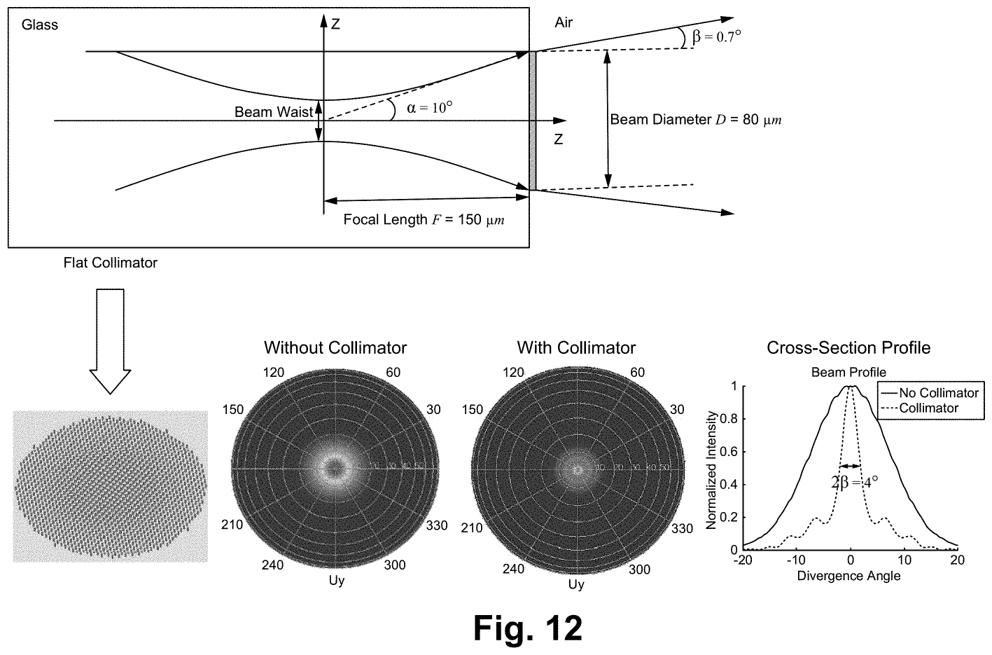

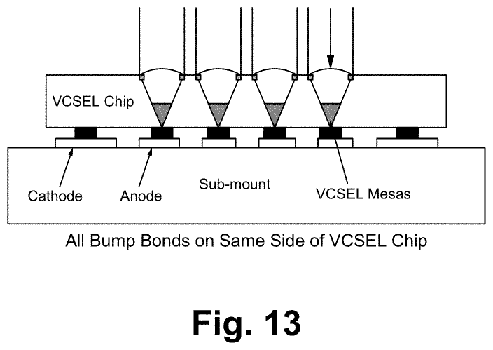

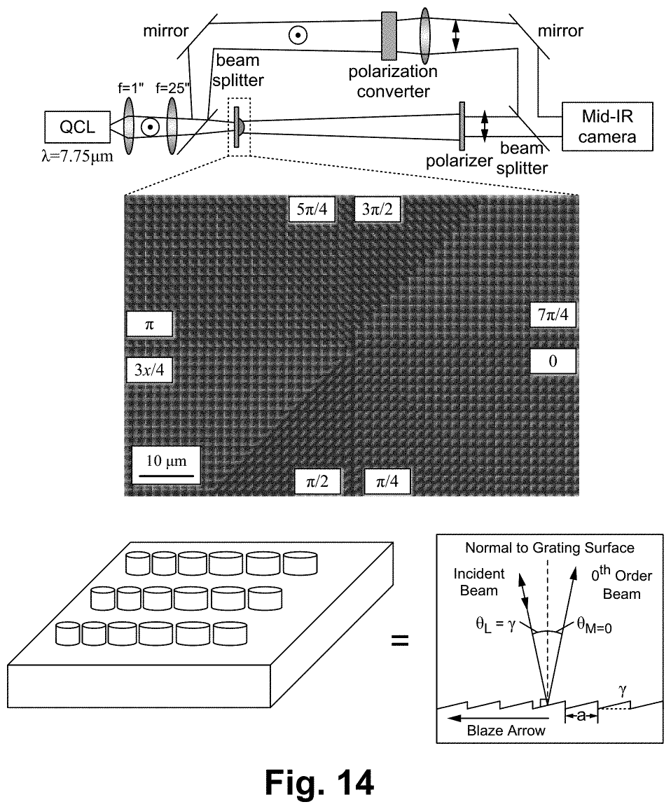

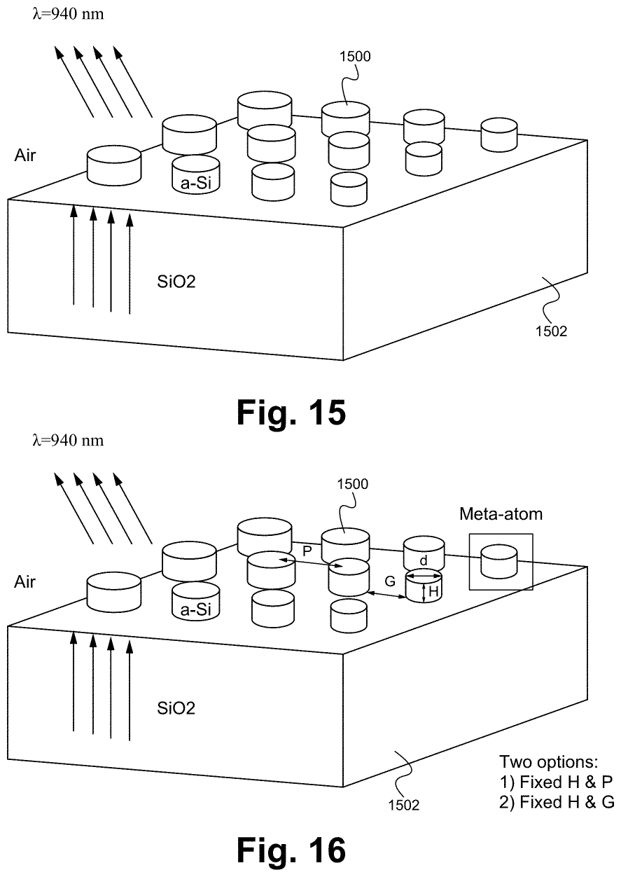

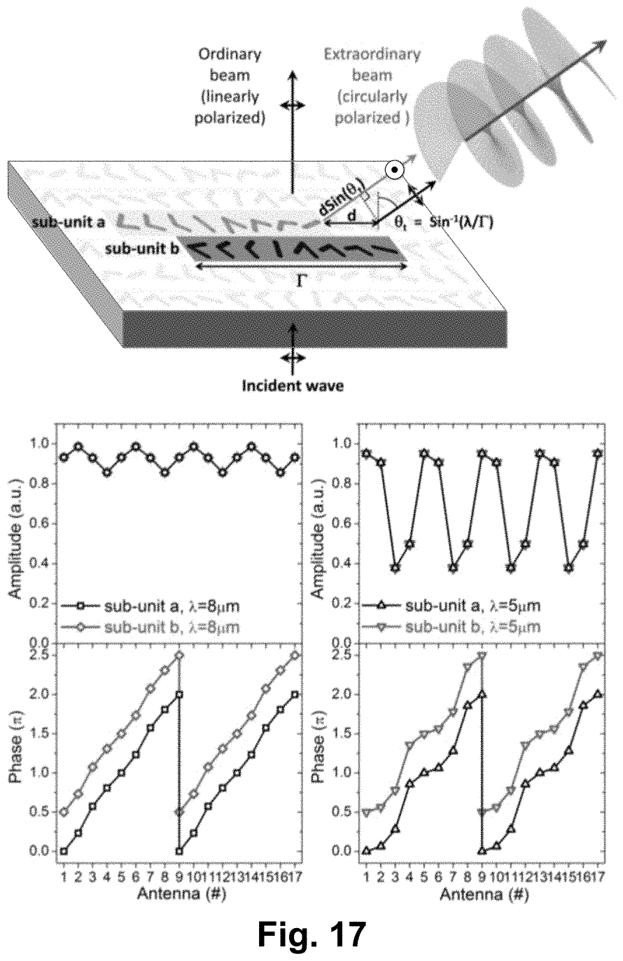

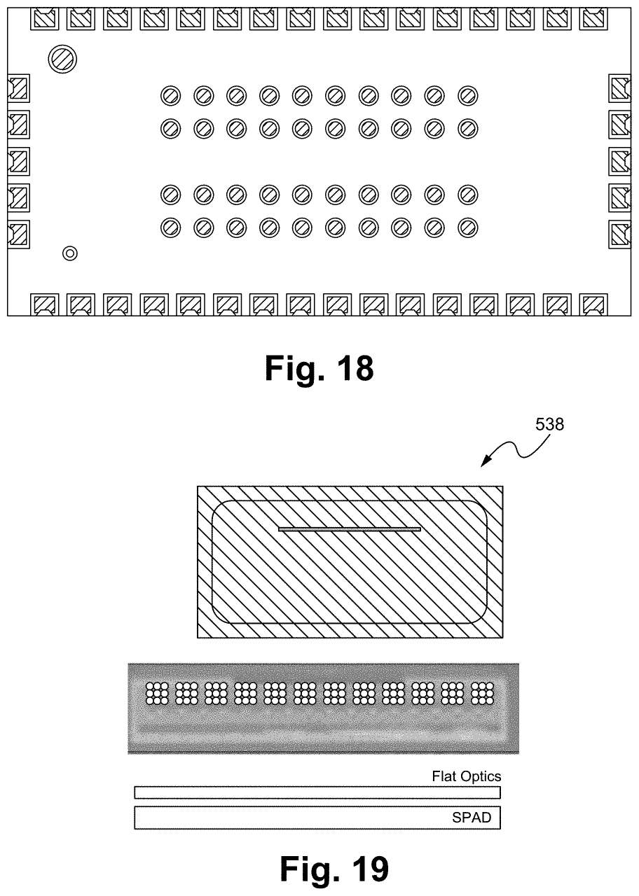

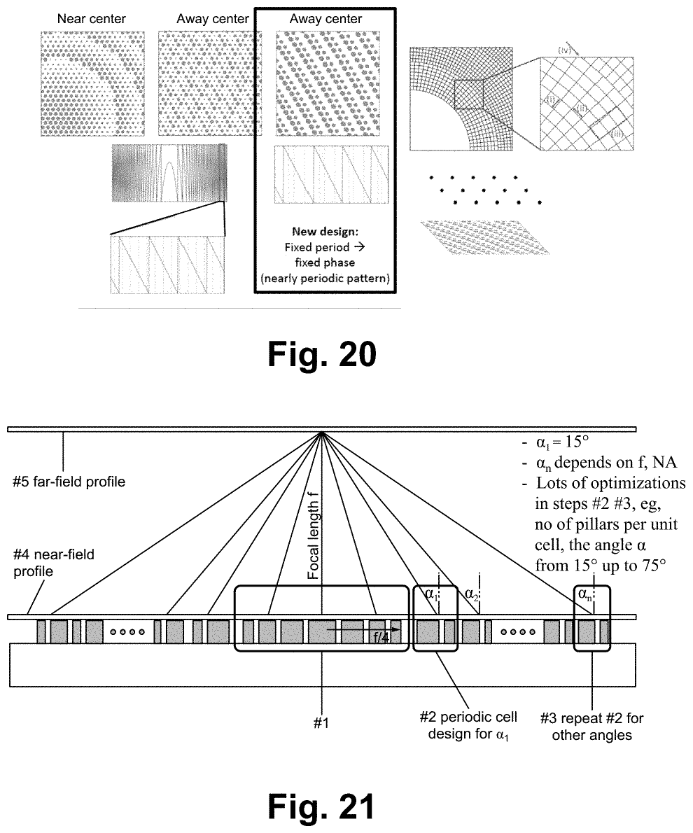

In some embodiments of the VCSEL light source, the VCSEL contains multiple dies to form an array as shown in FIG. 11, and each light-emitting element within the die can be bundled to form one discrete quantized beamlet, and each beamlet can be individually selected, controlled, and adjusted by programmable computer software. In order to take advantage of the individual emitter of the VCSEL array, there can be metasurface flat optics to collimate the laser with a typical divergence angle greater than ten degrees down to less than one degree as shown in FIG. 12 and form multiple beamlets propagating as parallel wavefront towards the beamsplitter. FIG. 13 shows the placement of flat optics relative to the VCSEL array, and how light is more collimated by the flat optics. After collimation, the collimated beams are then passed through a beamsplitter before entering the metasurface based flat optics deflector lens. The purpose of the deflector lens is to deflect the beams to a set of specific vertical elevations as shown in FIGS. 14-16. On the individual antenna pillar level, each pillar polarizes the incident beam at the subwavelength level, and with each pillar offset by a certain phase delay to deflect the incoming light beam to an intended angle as shown in FIG. 17. For each vertical angular position, it can be named as a channel, and the maximum total number of channels in the LiDAR can be defined by the total number of the emitter and detector pairs which span over a range of vertical elevation angles which are defined as Vertical Field of View (V-FOV). Similarly, FIG. 18 shows one of the configurations of the SPAD array, which includes multiple Avalanche Photo Diode (APD) elements that can be individually selected. Above the SPAD array, there are flat optics in order to focus the reflected light returning from the targets into the individual detector element as shown in FIG. 19. The individual detector element on the SPAD array is aligned with the focusing flat optics in order to receive incoming reflected light corresponding to a particular illuminated portion of the target by the emitter(s) of a specific vertical elevation. FIGS. 20 and 21 show how the metasurface based flat optics focusing lens can focus the reflected light from the target into an individual detector element.

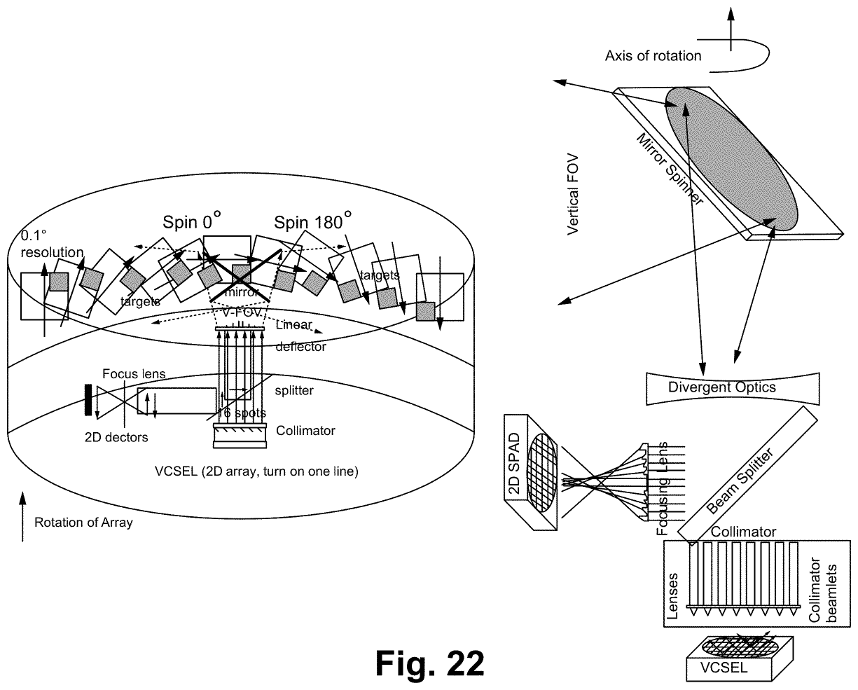

The spatial resolution or the channel resolution is determined by the physical angular pitch between two adjacent channels. The angular pitch for the vertical elevation is determined by three factors; (1) the relative spacing between the adjacent emitters, (2) the relative pitch angles of the collimating flat optics array which is located on top of the VCSEL array, and (3) the relative pitch angles of the focusing flat optics array on top of the SPAD array. In order to achieve a high vertical spatial resolution, the emitters are densely packed in the semiconductor chip and forms a dense linear grid with the corresponding detector array as shown in FIG. 22. As the periscope scanner rotates about its vertical axis, the integrated optical system can ultimately cover a wide range of vertical elevation angles with a varying angular resolution for any given starting vertical angle. In some embodiments, less than 0.1-degree vertical resolution per channel is achieved. In terms of the emitter to detector channel arrangement, there can be various combinations for each channel. There can be one emitter to one detector, many emitters (e.g., 10-50 emitters) to one detector, or many emitters to many detectors (e.g., 50 emitters to 2 detectors). To direct the light source to a desired vertical elevation, there are metasurface flat optics and a collimating lens in front of the VCSEL and then follow by the metasurface-based flat optics for deflection as described herein. An important aspect of the LiDAR optical system is that the combination of the flat optics and scanner result in variable image resolution depending on the elevation angle and the azimuthal angle. As described herein, the purposes of the three different flat optics lenses are (1) to collimate, (2) to deflect, and (3) to focus both the outgoing light as well as the returning light. The advantage of flat optics is the reduction in the height dimension which allows the overall system to be compactly arranged.

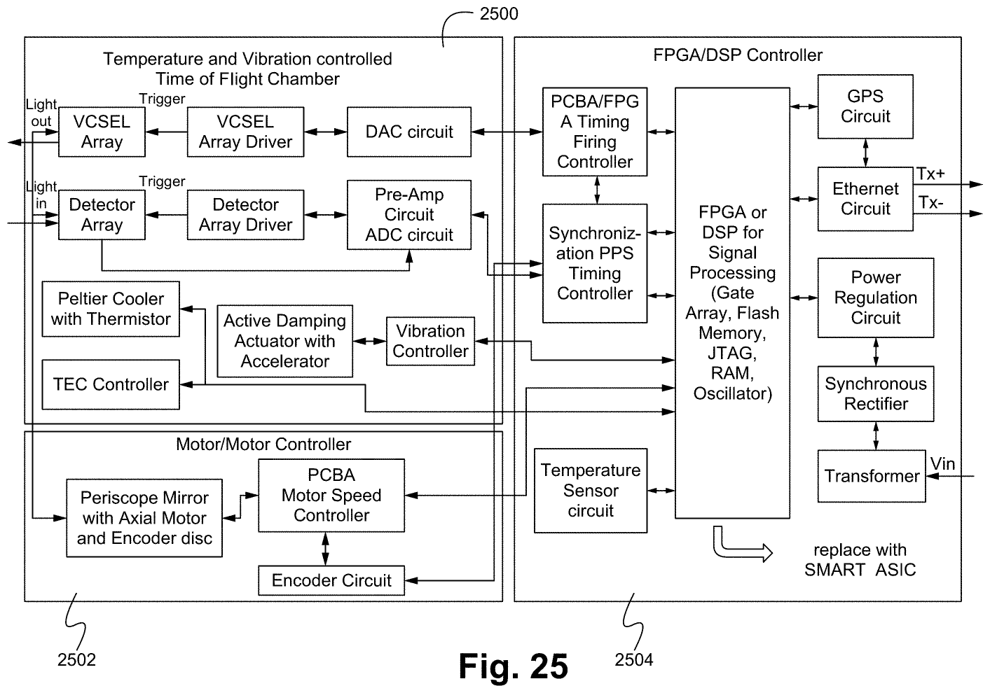

The timing control of the individual channel is accomplished with the controlling electronics which simultaneously trigger the laser firing and turn on the detector. The electronics of the TOF system provide the synchronization of laser firing and opening of the detector window to receive light. In such a sequence, the electronics measure the time for the photon to traverse from the laser source to the target and back from the target to the detector (refer to FIG. 25). The VCSEL, SPAD, and triggering electronics are important components of the TOF system. Finally, for three-dimensional sensing, the construction of the point cloud in the TOF system is based on summing all the data points generated from the channels of various vertical elevations and for 360-degree azimuthal angles.

In order to synchronize the laser firing and return light to the detector for the purpose of range determination, there is a set of electronics to coordinate the sequence of triggering and switching as represented by the block diagram in FIG. 25. The electronics also control the motor rotation 2502 and how the motor is in sync with the laser firing and detection of the returned light. The digital trigger activates the laser driver to fire the laser pulse, and at the same time turns on the detector window to detect the return light from the target. The amount of time elapsed before the detector detects the returned light from the target is used to determine the distance between the target and the sensor since the speed of light is a known constant. The converted distance value can then be determined by the FPGA 2504 and communicate to the outside world. In addition, the amplitude of the analog return signal which signifies the reflectance of the target can then be converted to digital counts, and the FPGA 2504 processes the amplitude/digital counts to report the relative reflectance of the target. Together for any given targeted point in space, there can be the spatial coordinates of the point, the time it takes to travel to the target and back, and the reflectance of the target. The 3D point cloud is therefore formed by aggregating all the points and representing them in a 3D format. A temperature and vibration controlled ToF chamber 2500 includes several aspects of the system.

As described herein, the optical elements for the TOF or LiDAR optical system include: VCSEL as the light source, SPAD as the detectors, collimation lens, focusing lens, beam splitter (or mirror-hole), rotating mirror, vertical optical scanner, and the electronics that control the active devices. The configuration shows the integration of the VCSEL and SPAD arrays into the LiDAR whereby the VCSEL can function as a light source, and the SPAD can function as a light detector. In some embodiments, the VCSEL and SPAD arrays are tuned to either IR 905 nm or IR 940 nm wavelength. However, a person of ordinary skill in the art appreciates that the implementation disclosed herein can accommodate other wavelengths of light as well.

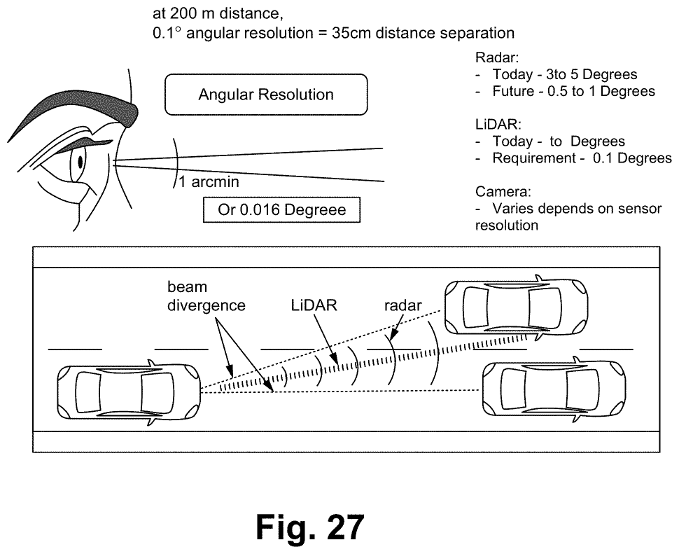

The arrangement of the metasurface-based flat optics which bundles the emitters of the VCSEL array and detectors on the SPAD array is important. The pillars 1500 on the transparent glass substrate 1502 are densely packed with a specific height and pillar diameter to be able to deflect light to a particular set of angular positions. In some embodiments, the transparent substrate is SiO₂, and the pillars are amorphous silicon. The set of angular positions are what determines the spatial resolution and FOV (as an example for 0.1-degree vertical separation between channel means the aspect ratio of ˜500 to 1 in length vs. height which equates to a channel spacing of 35 cm for an object at 200 m away as shown in FIG. 27). The angular pitch is accomplished with a combination of collimation flat optics, deflection flat optics, and focusing flat optics. They can be fabricated separately as semiconductor devices on a 300 mm wafer (or other size) similar to that of the CMOS fabrication process flow. After the wafer process, the lens can be diced from the wafer and then packaged with the VCSEL and SPAD dies to form an integrated light transmission array or light detection array (refer to FIG. 11 and FIG. 18 for the dimensions of the VCSEL and SPAD devices, and FIG. 12 and FIG. 19 for the integration of the optics with the active elements). The implementation disclosed herein can accommodate various VCSEL and SPAD configurations as long as the input driver and the output signal line are compatible with the driving circuitry.

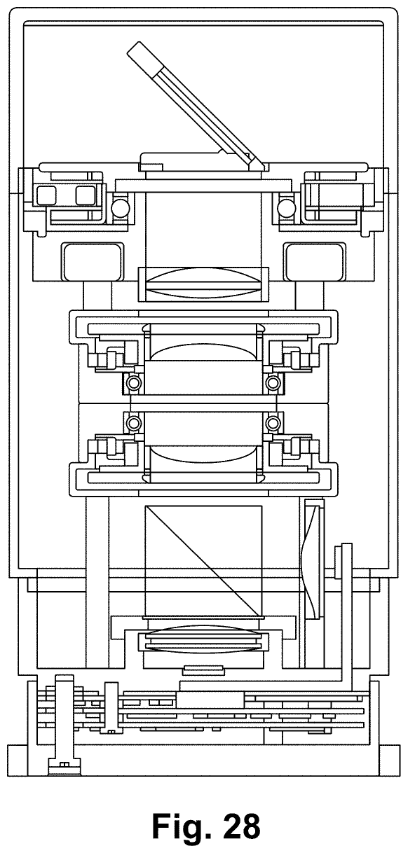

For high spatial resolution in both vertical and horizontal directions, the light source from the emitters is first collimated by the metasurface collimating flat optics (the collimation lens reduces or eliminates the divergence of the beam). For beam steering of both emitter and detector, a combination of a collimation lens and a focusing lens is used. They typically are situated in front of the active element and behind a vertical scanner as shown in FIGS. 12 and 19. The collimating lens can contain pillar arrays to bend the light beam to a specific angle as shown in FIGS. 14-16, and its function is to eliminate the beam divergence. For the vertical scanner, there are at least two design options: one is Risley Prisms and another is metasurface flat optics as shown in FIG. 28 and FIG. 10, respectively. The periscope scanner performs two key functions (1) scan the vertical elevation range and (2) varies the vertical elevation angle by transforming from the Cartesian coordinates to Polar coordinates as shown in FIG. 22. In some embodiments, the outgoing path of the laser light after the beam collimation can enter the Risley prism or metasurface element before the periscope mirror.

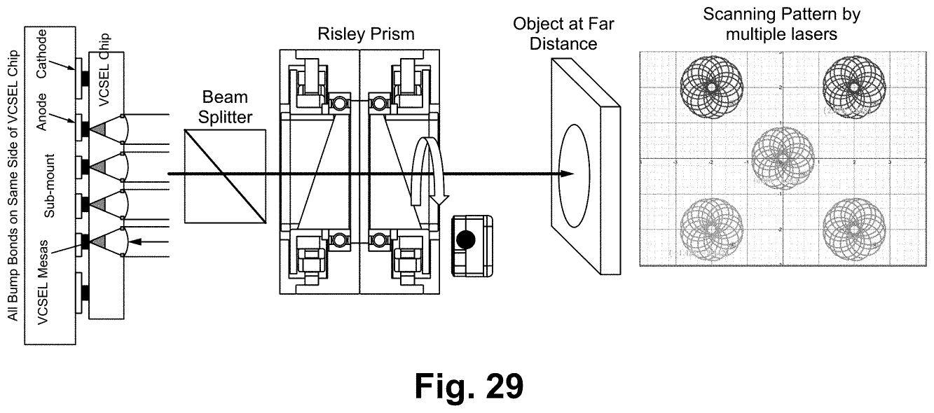

The Risley prisms scanner can steer the light by rotating two independent wedges in opposite directions to each other (each wedge mounted on an axial field motor) as shown in FIG. 29. When the two wedges co-rotate, the prism scanner system can steer the laser beam vertically as shown in FIG. 29. To achieve a high frame rate (vertical scan speed), the rotation of the axial field motor for the Risley prism should be high speed (on the order of 100 kHz to 1 MHz). This uses a high emitter repetition rate (on the order of MHz) to accommodate the high spatial resolution in the azimuthal/horizontal directions.

In a simpler version, metasurface-based flat optics with the periscope can accomplish high spatial resolution without the need to rotate the periscope at a high speed. It is important to note that the speed of the motor is controlled by the optical encoder mounted at the bottom surface of the axial field motor as shown in FIG. 5. After the light passes through the vertical scanner, it enters the rotating periscope mirror which can then scan the entire 360 azimuthal angular range. The motor to rotate the periscope mirror is made of axial field pancake-like stators and permanent magnets. When the stator is energized, it exerts an in-plane force on the permanent magnets, which then rotates the mirror around the axis of rotation as shown in FIG. 26.

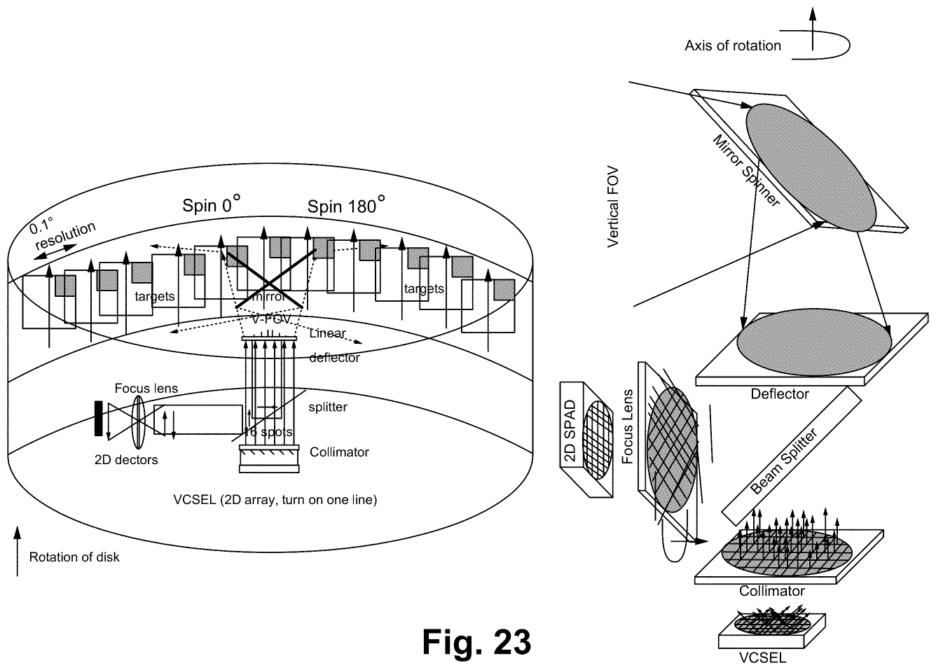

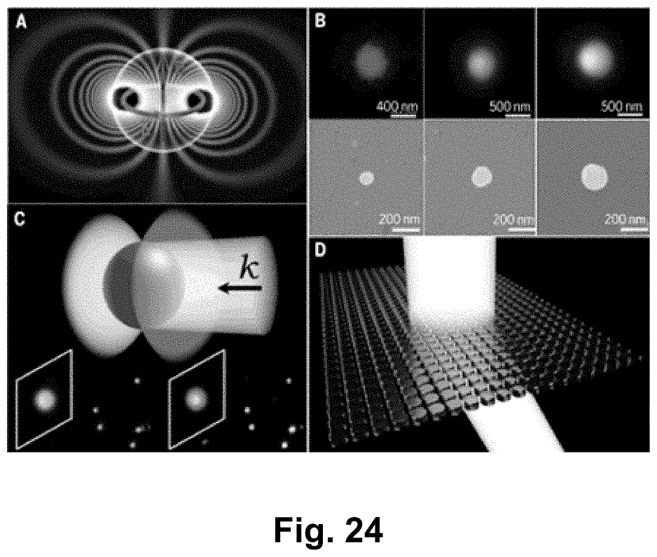

A flat optics/metasurface can replace the Risley prism and perform the same functions without the mechanical rotation. This improves field reliability as well as the compactness of the overall LiDAR system. A flat optics/metasurface implementation includes compactness in the height dimension (with a dimension of less 100 mm in height and 80 mm in diameter) as a result of integrating flat optics to the system. In such a scenario, an array of subwavelength geometric elements of certain width and height can be arranged into a repetitive pattern, and they can be fabricated on a transparent substrate with a semiconductor process as shown in FIG. 24. As the light passes through these elements, they polarize the beam and act as an optical antenna which results in deflecting the light beam to a specific angle similar to that of blaze grating as shown in FIG. 14. In FIG. 22 or FIG. 23, the light passes through the flat optics can be steered vertically as well as changing the deflection angle radially which resulted in the transformation of the reference frame or coordinates in space.

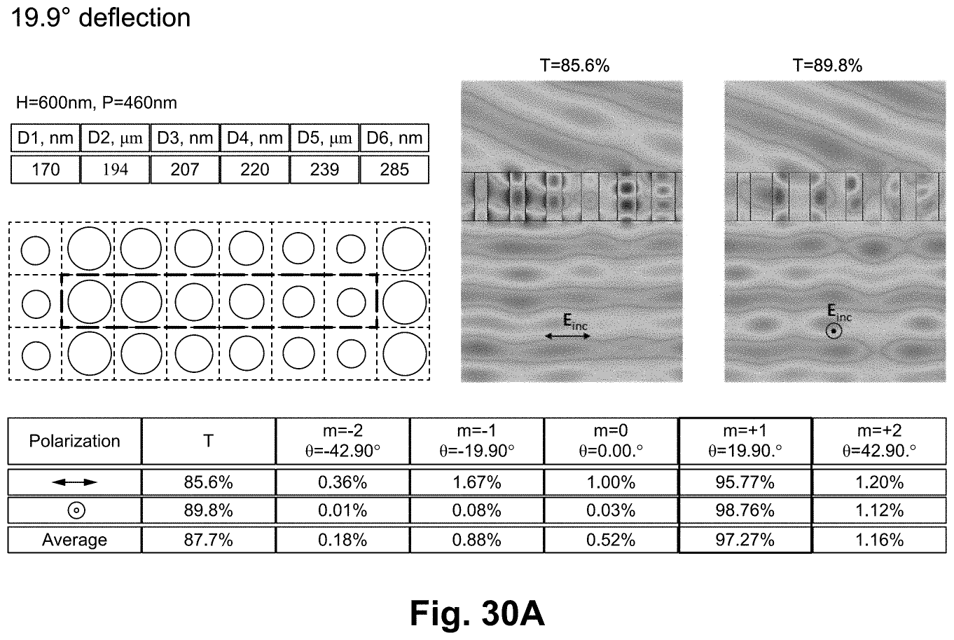

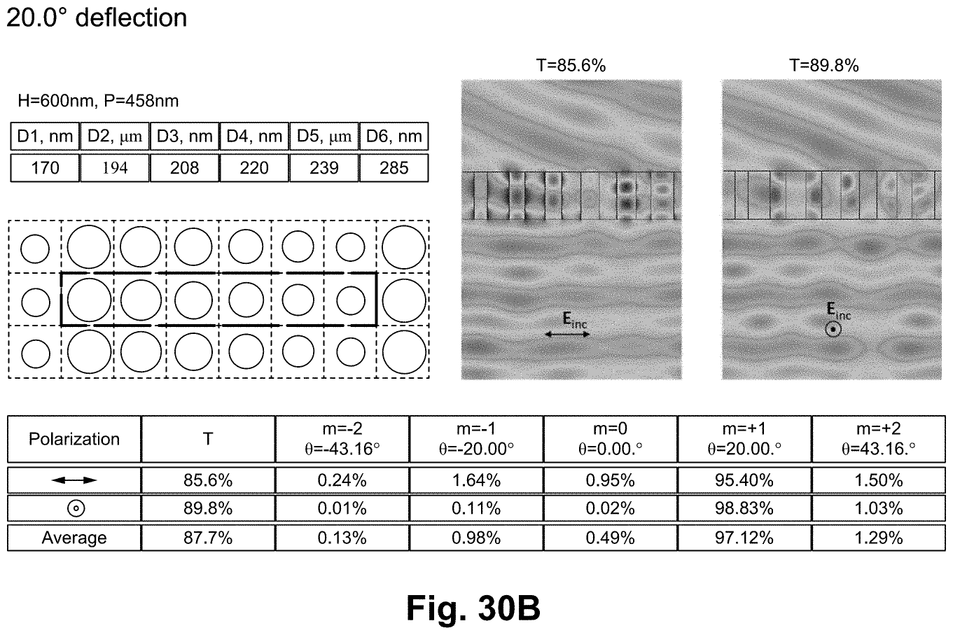

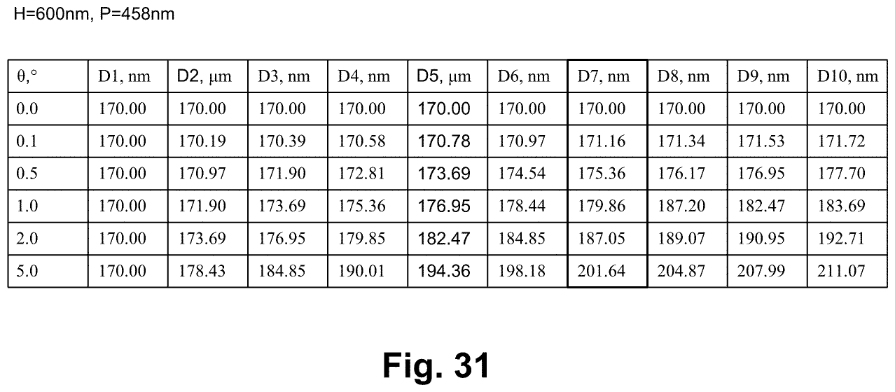

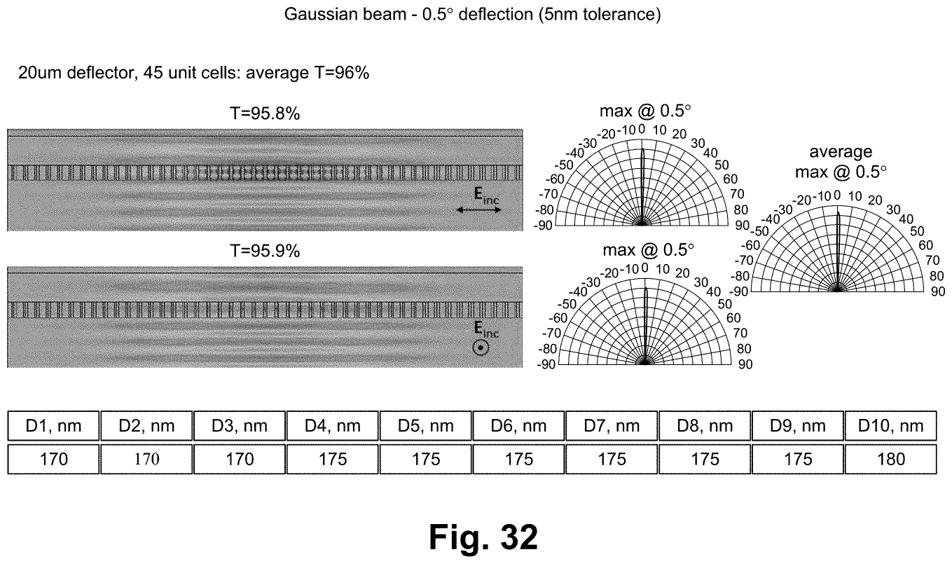

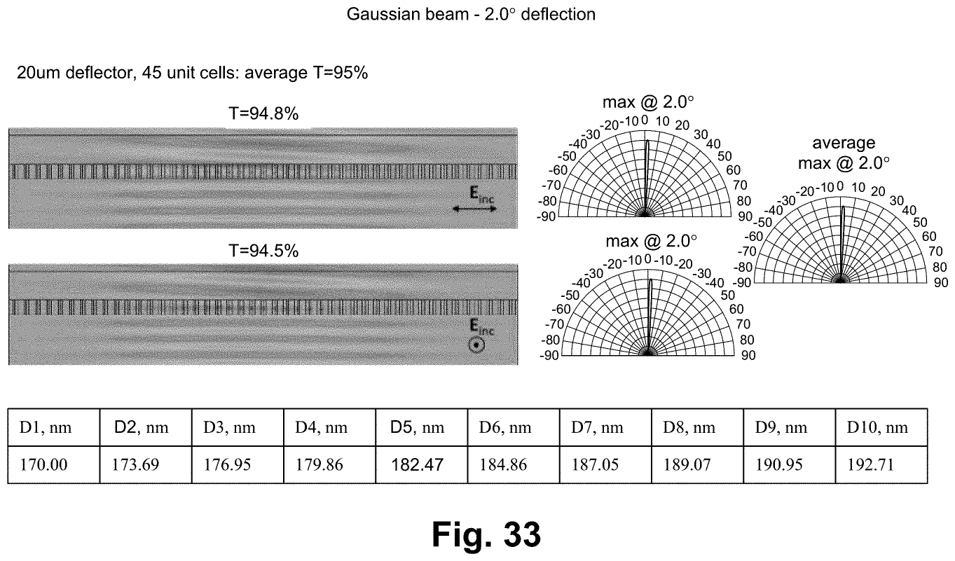

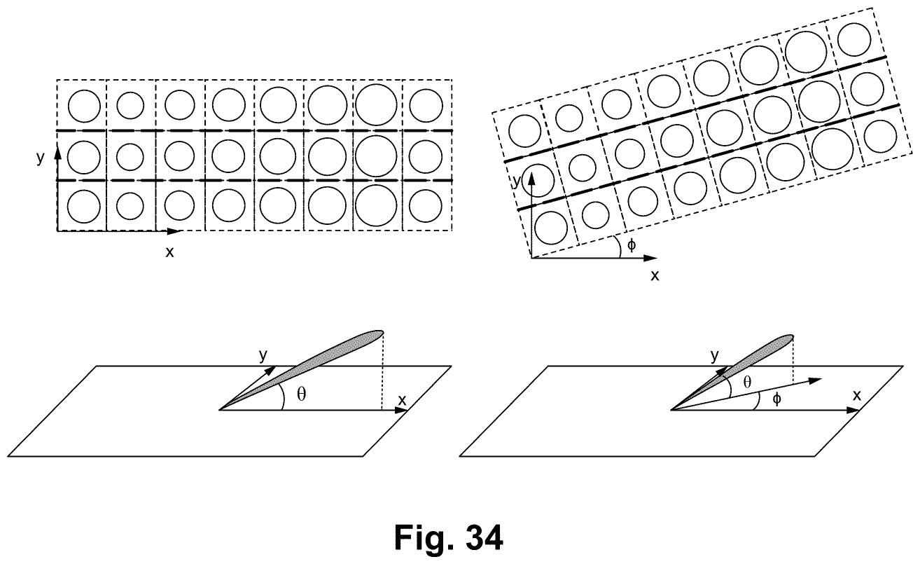

In order to toggle between the far-field vs. near-field illumination, the system has the capability to vary the elevation angles. The pitch of the flat optics array and the deflecting angle of the individual emitter of the VCSEL are determined by a group of pillars of specific height and diameters. The group is also termed as the unit cell, and together deflects the light beam to a specific vertical angle as shown in FIGS. 30A-B, 31, 32 and 33. The total coverage of the elevation angles which is also termed as the Field-of-View can be determined by the total number of unit cells with each unit cell defining a specific elevation angle. In addition to vertical angle θ deflection, there can be in plane angle φ deflection by changing the pillar in plane orientation relative the adjacent unit cell as shown in FIG. 34.

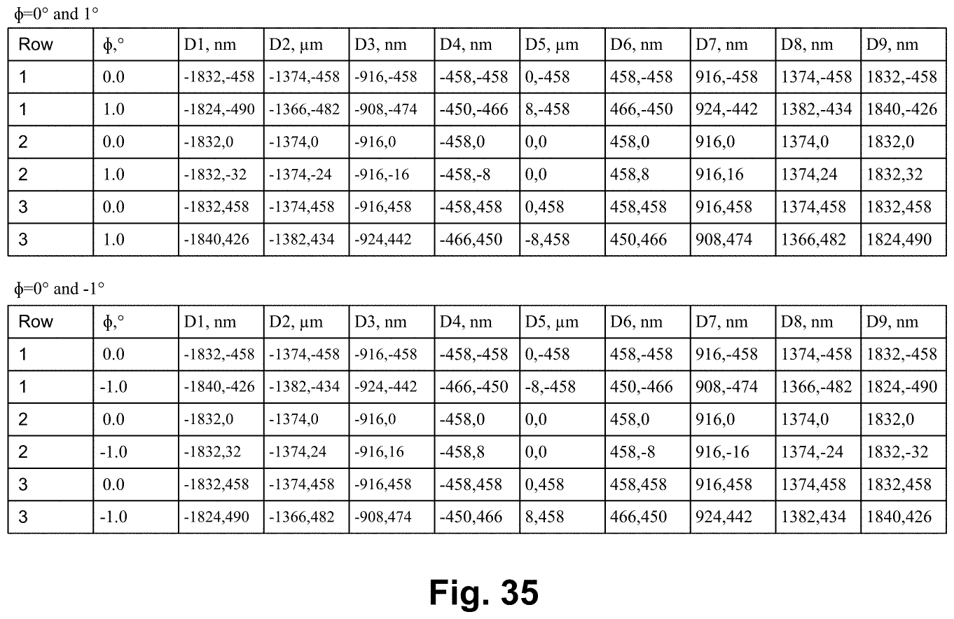

FIG. 35 illustrates the combination of θ and φ angles deflection by a set of pillars of specific diameters according to some embodiments. Grouping of rows show there can be different diameters of pillars combination to achieve the relative φ deflection angle. Once the alignment of the beam for a given vertical elevation is defined at the flat optics level for a given bundle of light or a given channel, the Risley prism rotation or the metasurface performs the vertical steering of the beam to achieve the desired spatial resolution (in some embodiments, a desirable resolution is less than 0.1 degree). Similar to the optical arrangement between the VCSEL array and the collimating flat optics, a focusing flat optics can be placed in front of the SPAD array to focus the light onto the individual detector element as shown in FIG. 19. The return beam from the target can enter the periscope and from the periscope to the focusing flat optics as shown in FIG. 22 and FIG. 23. Similarly, the deflecting flat optics and the focusing flat optics can steer the returned beam onto the corresponding detector by transforming from the Polar coordinates to Cartesian coordinates.

Ten pillars (or another number) form a unit cell which dictates a specific deflection angle. For example, if there are 32 different deflection angles, then 320 pillars would be utilized (grouped in tens), where each grouping addresses a different deflection angle. If there are 32×32 emitters, then there will be 1000 different angles. In some embodiments, each of the pillars has a different diameter and/or height which affects the direction of the light wave. The pillars are able to be arranged in any unique sequence (e.g., concentric circles, a checkerboard, a single circle). The pillars delay a portion of the wavefront coming from the bottom of the transparent substrate, and then the wave is partitioned by the pillars and delayed in slightly different amounts by the pillars, and the combination of the segments makes up the overall angle (e.g., blazing angle). In some embodiments, the number of unit cells or groups of pillars matches the number of emitter/detector pairs, and in some embodiments, the numbers do not match. For example, if there are 1000 pairs of emitters/detectors, there may be 1000 corresponding unit cells. In another example, there are more unit cells than emitter/detector pairs. The number of unit cells is able to determine the resolution of images. In some embodiments, the number of unit cells depend on semiconductor processing capability. There is a matching of the laser duty cycles and the motor speed with the number of the unit cells, as they all work together to define the vertical and horizontal separation between the two adjacent pairs or unit cells. The angular resolution is determined by the frame rate which is the speed of the periscope rotation and the laser firing repetition rate or duty cycle, and the angular separation of the unit cells on the flat optics.

The collimating lens, deflecting lens and focusing lens are all able to utilize the metasurface flat optics to deflect/guide light to a specific angle. The collimating lens and the deflecting lens are similar but different, in that they both utilize the metasurface flat optics to guide the light wave/laser beam, but one is a converging lens (e.g., collimating) and the other is a diverging lens (e.g., deflecting). For the deflecting lens, the light is pointed away from the center. For the collimating lens, the light is pointed toward the center. Similarly, the focusing lens is able to include pillars in the shapes of concentric rings, and each ring has a set of pillars that steer the light toward the center.

Switching from the near field to the far field can be accomplished with the embedded algorithm on the electronics given that each bundle of light can be individually addressed. Furthermore, the same electronics coordinate the sequence of triggering and switching in order to synchronize the laser firing and returned light to the detector for the purpose of range determination as represented by the block diagram in FIG. 25. The electronics also control the motor rotation and how the motor is in sync with the laser firing and detection of the returned light. The digital trigger activates the laser driver to fire the laser pulse and at the same time turns on the detector window to detect return light from the target. The amplitude of the analog return signal signifies the reflectance of the target which is then converted to digital counts and the FPGA processes it to report the reflectivity of the target. From the time it takes for the light to traverse from the source to the target and back, the time counter reports the time elapsed value to the FPGA. The elapsed time can then be translated into a precise distance because the speed of the light is constant. Finally, two sets of information can be derived for any given targeted point in space, (1) there is the spatial coordinates of the point and (2) the reflectivity of the target. The 3 Dimensional point cloud in the form of reflectance mapping of the surrounding targets is generated by aggregating all the points and representing them with the x, y, z cartesian coordinates. The transformation of coordinates is part of the system design and that comes without any post processing. Software is not needed to decode the location of the points corresponding to the 3D spatial location but that is able to be easily determined by knowing the frame rate, laser duty cycle, and the angular separation of the flat optics.

To utilize the flat optics described herein, a pillar array on a transparent substrate can steer a laser beam from a stationarily mounted emitter and project the laser beam radially as the periscope rotates. The pillar array on the transparent substrate can steer the laser beam from a stationarily mounted emitter to a given vertical elevation. The flat optics are able to be incorporated in a LiDAR optical system or another device which is utilized with a vehicle, or more specifically, an autonomous vehicle, to perform a mapping of the surroundings. Based on the mapping, the vehicle is able to perform functions such as avoiding obstacles or alerting a driver. The LiDAR optical system is able to be positioned anywhere on the vehicle such as on the top, front, rear or sides. The LiDAR optical system is able to communicate with the vehicle in any manner such as by wired or wirelessly sending signals to a computing system of the vehicle which is able to take the LiDAR information and perform actions such as stopping the vehicle, changing lanes, and/or triggering an alert in the vehicle.

In operation, the design of the pattern, thinness of the flat optics, the capability to perform the coordinate transformation, and beam steering are some of the novel features of the flat optics disclosed herein. Further, the flat optics allows the overall height dimension of the LiDAR optical system to be very compact.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus comprising:
a laser emitting source configured for emitting a laser beam;
a collimating lens configured for collimating the laser beam from the laser emitting source, wherein the collimating lens comprises a first metasurface flat optics lens;
a deflecting lens configured for deflecting the laser beam at a specified angle, wherein the deflecting lens comprises a second metasurface flat optics lens;
a reflecting mirror on a motor;
a light detection array configured for receiving the returned laser beam;
a focusing lens configured for focusing the returned laser beam to the light detection array, wherein the focusing lens comprises a third metasurface flat optics lens; and
an optical beam splitter configured for enabling a path of the laser beam from the laser emitting source to the reflecting mirror out to a target and the returned laser beam reflected from the target back to the light detection array.

2. The apparatus of claim 1 wherein the first metasurface flat optics lens, the second metasurface flat optics lens, and the third metasurface flat optics lens each comprise:
a transparent substrate; and
a plurality of pillars on top of the transparent substrate configured for directing the laser beam and the returned laser beam, wherein the plurality of pillars are grouped by ‘n’ pillars to form a ‘unit cell’ which dictates a specific deflection angle, wherein the transparent substrate comprises SiO₂, and the plurality of pillars comprise amorphous silicon, wherein the plurality of pillars comprise a plurality of sizes of pillars, including a plurality of heights and a plurality of diameters.

3. The apparatus of claim 2 wherein the laser emitting source comprises 32×32 light emitters, and the plurality of pillars comprise 320 pillars including 32 unit cells.

4. The apparatus of claim 2 wherein the 32×32 light emitters emit light simultaneously, pointing at different elevation angles at the same time, and the returning light is received at the light detection array at approximately the same time depending on a distance of an object for each laser beam.

5. The apparatus of claim 2 wherein a grouping of the unit cells for the collimating lens is to bend the light inward; the grouping of the unit cells for the deflecting lens is to bend the light outward, and the grouping of the unit cells for the focusing lens is bend the light inward.

6. The apparatus of claim 2 wherein the focusing lens includes the plurality of pillars in a shape of concentric rings, and each ring has a set of pillars that steer the light inward.

7. The apparatus of claim 2 wherein the deflecting lens is configured to rotate to change the elevation of the light from each of the 32×32 light emitters by rotating the deflecting lens to a different horizontal angle which changes the reference frame of the vertical elevation angles, further wherein the received light is stitched together to generate a dense image resolution.

8. The apparatus of claim 2 wherein the plurality of pillars on top of the transparent substrate are arranged to form a geometric pattern for light transmission from a Vertical-Cavity-Surface-Emitting Laser (VCSEL) array to a target and from the target to a Single-Photon Avalanche Detector (SPAD) array.

9. The apparatus of claim 2 wherein the transparent substrate is configured with patterned geometric elements and operates in a transmission mode for light with near infrared wavelength.

10. The apparatus of claim 2 wherein the plurality of pillars on top of the transparent substrate are configured to steer the laser beam from the laser emitting source which is stationarily mounted and project the laser beam radially as the reflecting mirror rotates.

11. The apparatus of claim 2 wherein the plurality of pillars on top of the transparent substrate are configured to steer a laser beam from the laser emitting source which is stationarily mounted emitter to a specified vertical elevation.

12. The apparatus of claim 1 wherein the laser beam passes through the deflecting lens and is steered and changes a deflection angle radially for transformation of coordinates.

13. The apparatus of claim 1 wherein the deflecting lens is positioned behind the reflecting mirror of a rotating periscope to transform a frame of reference and steer the laser beam vertically to enable far-field and near field illumination.

14. A system comprising:
a plurality of metasurface flat optics lenses, each lens comprising:
a transparent substrate; and
a plurality of pillars on top of the transparent substrate configured for directing a laser beam and a returned laser beam; and
a Light Detection and Ranging (LiDAR) optical device including the metasurface flat optics lens, the LiDAR optical device comprising:
a laser emitting source configured for emitting the laser beam;
a reflecting mirror on a motor;
a light detection array configured for receiving the returned laser beam;
an optical beam splitter or mirror-hole configured for enabling a path of the laser beam from the laser emitting source to the reflecting mirror out to a target and the returned laser beam reflected from the target back to the light detection array.

15. The system of claim 14 wherein the plurality of metasurface flat optics lenses comprise a collimating lens, a deflecting lens, and a focusing lens, and wherein the plurality of pillars are grouped by ‘n’ pillars to form a ‘unit cell’ which dictates a specific deflection angle, wherein the transparent substrate comprises SiO₂, and the plurality of pillars comprise amorphous silicon, wherein the plurality of pillars comprise a plurality of sizes of pillars, including a plurality of heights and a plurality of diameters.

16. The system of claim 15 wherein the laser emitting source comprises 32×32 light emitters, and the plurality of pillars comprise 320 pillars including 32 unit cells.

17. The system of claim 15 wherein the 32×32 light emitters emit light simultaneously, pointing at different elevation angles at the same time, and the returning light is received at the light detection array at approximately the same time depending on a distance of an object for each laser beam.

18. The system of claim 15 wherein a grouping of the unit cells for the collimating lens is to bend the light inward; the grouping of the unit cells for the deflecting lens is to bend the light outward, and the grouping of the unit cells for the focusing lens is bend the light inward.

19. The system of claim 15 wherein the focusing lens includes the plurality of pillars in a shape of concentric rings, and each ring has a set of pillars that steer the light inward.

20. The system of claim 15 wherein the deflecting lens is configured to rotate to change the elevation of the light from each of the 32×32 light emitters by rotating the deflecting lens to a different horizontal angle which changes the reference frame of the vertical elevation angles, further wherein the received light is stitched together to generate a dense image resolution.

21. The system of claim 15 wherein the plurality of pillars on top of the transparent substrate are arranged to form a geometric pattern for light transmission from a Vertical-Cavity-Surface-Emitting Laser (VCSEL) array to a target and from the target to a Single-Photon Avalanche Detector (SPAD) array.

22. The system of claim 15 wherein the transparent substrate is configured with patterned geometric elements and operates in a transmission mode for light with near infrared wavelength.

23. The system of claim 15 wherein the plurality of pillars on top of the transparent substrate are configured to steer the laser beam from the laser emitting source which is stationarily mounted and project the laser beam radially as the reflecting mirror rotates.

24. The system of claim 15 wherein the plurality of pillars on top of the transparent substrate are configured to steer a laser beam from the laser emitting source which is stationarily mounted emitter to a specified vertical elevation.

25. The system of claim 14 wherein the laser beam passes through a deflecting lens and is steered and changes a deflection angle radially for transformation of coordinates.

26. The system of claim 14 wherein a deflecting lens is positioned behind the reflecting mirror of a rotating periscope to transform a frame of reference and steer the laser beam vertically to enable far-field and near field illumination.

27. The system of claim 14 wherein the system is 100 mm or less in height and 80 mm or less in diameter.

28. A method programmed in a non-transitory of a device comprising:
emitting a laser beam from a laser emitting source;
collimating the laser beam from the laser emitting source with a first metasurface flat optics lens comprising:
a transparent substrate; and
a plurality of pillars on top of the transparent substrate configured for directing the laser beam and a returned laser beam;
deflecting the laser beam at a specified angle with a second metasurface flat optics lens;
receiving the returned laser beam with a light detection array;
focusing the returned laser beam to the light detection array with a third metasurface flat optics lens; and
enabling, with an optical beam splitter, a path of the laser beam from the laser emitting source to a reflecting mirror on a motor out to a target and the returned laser beam reflected from the target back to the light detection array.

29. The method of claim 28 wherein the first metasurface flat optics lens, the second metasurface flat optics lens, and the third metasurface flat optics lens each comprise:
a transparent substrate; and
a plurality of pillars on top of the transparent substrate configured for directing the laser beam and the returned laser beam, wherein the plurality of pillars are grouped by ‘n’ pillars to form a ‘unit cell’ which dictates a specific deflection angle, wherein the transparent substrate comprises SiO₂, and the plurality of pillars comprise amorphous silicon, wherein the plurality of pillars comprise a plurality of sizes of pillars, including a plurality of heights and a plurality of diameters.

30. The method of claim 29 wherein the laser emitting source comprises 32×32 light emitters, and the plurality of pillars comprise 320 pillars including 32 unit cells.

31. The method of claim 29 wherein the 32×32 light emitters emit light simultaneously, pointing at different elevation angles at the same time, and the returning light is received at the light detection array at approximately the same time depending on a distance of an object for each laser beam.

32. The method of claim 29 wherein a grouping of the unit cells for the collimating lens is to bend the light inward; the grouping of the unit cells for the deflecting lens is to bend the light outward, and the grouping of the unit cells for the focusing lens is bend the light inward.

33. The method of claim 29 wherein the focusing lens includes the plurality of pillars in a shape of concentric rings, and each ring has a set of pillars that steer the light inward.

34. The method of claim 29 wherein the deflecting lens is configured to rotate to change the elevation of the light from each of the 32×32 light emitters by rotating the deflecting lens to a different horizontal angle which changes the reference frame of the vertical elevation angles, further wherein the received light is stitched together to generate a dense image resolution.

35. The method of claim 29 wherein the plurality of pillars on top of the transparent substrate are arranged to form a geometric pattern for light transmission from a Vertical-Cavity-Surface-Emitting Laser (VCSEL) array to a target and from the target to a Single-Photon Avalanche Detector (SPAD) array.

36. The method of claim 29 wherein the transparent substrate is configured with patterned geometric elements and operates in a transmission mode for light with near infrared wavelength.

37. The method of claim 29 wherein the plurality of pillars on top of the transparent substrate are configured to steer the laser beam from the laser emitting source which is stationarily mounted and project the laser beam radially as the reflecting mirror rotates.

38. The method of claim 29 wherein the plurality of pillars on top of the transparent substrate are configured to steer a laser beam from the laser emitting source which is stationarily mounted emitter to a specified vertical elevation.

39. The method of claim 28 wherein the laser beam passes through the deflecting lens and is steered and changes a deflection angle radially for transformation of coordinates.

40. The method of claim 28 wherein the deflecting lens is positioned behind the reflecting mirror of a rotating periscope to transform a frame of reference and steer the laser beam vertically to enable far-field and near field illumination.

41. The method of claim 28 wherein duty cycles of the laser emitting source and a speed of the motor matches with a number of unit cells.
